(19) United States
(12) Patent Application Publication
(10) Pub. No.: US 2020/0262387 A1
(43) Pub. Date: Aug. 20, 2020

(54) VEHICULAR BABY REMINDER SYSTEM

(71) Applicant: PHILLIP WOODY, Normandy Park, WA (US)

(72) Inventor: PHILLIP WOODY, Normandy Park, WA (US)

(21) Appl. No.: 16/278,803

(22) Filed: Feb. 19, 2019

(51) Int. Cl. B60R 22/10; A47D 13/08; A01K 27/00

(52) U.S. Cl. CPC B60R 22/10; A01K 27/003; A47D 13/086

(57) ABSTRACT

The vehicular baby reminder system is a kit. The vehicular baby reminder system is a safety device. The vehicular baby reminder system simultaneously attaches to an infant or pet and a domestic article such that the when the custodian moves with the domestic article, the custodian will be reminded of their custodial responsibility regarding the infant. The vehicular baby reminder system comprises a tether, a plurality of loops, one or more signs and a carton. The plurality of loops attach the infant and the domestic article to the tether. Each of the one or more signs is a placard that displays a sentiment reminding the custodian of their custodial responsibility regarding the infant. The carton is a container used to store the tether, the plurality of loops, and the one or more signs.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of domestic and personal articles including furniture for children, more specifically, a safety harness for children. (A47D13/08)

### SUMMARY OF INVENTION

The vehicular baby reminder system is a kit. The vehicular baby reminder system is a safety device. The vehicular baby reminder system is configured for use with an infant or a pet. The vehicular baby reminder system is configured for use with a custodian of the infant. The vehicular baby reminder system is configured for use with a domestic article in the custody of the custodian. The vehicular baby reminder system simultaneously attaches to the infant and the domestic article such that the when the custodian moves with the domestic article, the custodian will be reminded of their custodial responsibility regarding the infant. The vehicular baby reminder system comprises a tether, a plurality of loops, one or more signs and a carton. The plurality of loops attach to the tether. A first loop selected from the plurality of loops further attaches to the infant. A second loop selected from the plurality of loops further attaches to the domestic article such that the custodian travels carrying both the domestic article and the infant. Each of the one or more signs is a placard that displays a sentiment reminding the custodian of their custodial responsibility regarding the infant. The carton is a container used to store the tether, the plurality of loops, and the one or more signs.

These together with additional objects, features and advantages of the vehicular baby reminder system will be readily apparent to those of ordinary skill in the art upon reading the following detailed description of the presently preferred, but nonetheless illustrative, embodiments when taken in conjunction with the accompanying drawings.

In this respect, before explaining the current embodiments of the vehicular baby reminder system in detail, it is to be understood that the vehicular baby reminder system is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the vehicular baby reminder system.

It is therefore important that the claims be regarded as including such equivalent construction insofar as they do not depart from the spirit and scope of the vehicular baby reminder system. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a perspective view of an embodiment of the disclosure.

FIG. 2 is a front view of an embodiment of the disclosure.

FIG. 3 is an in-use view of an embodiment of the disclosure.

FIG. 4 is a perspective view of an alternate embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

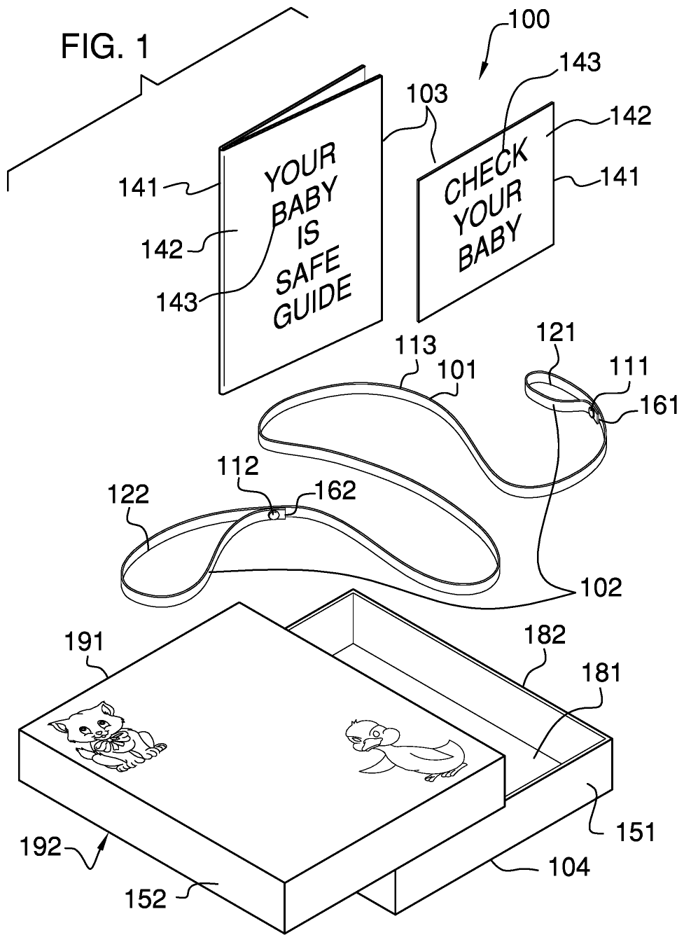

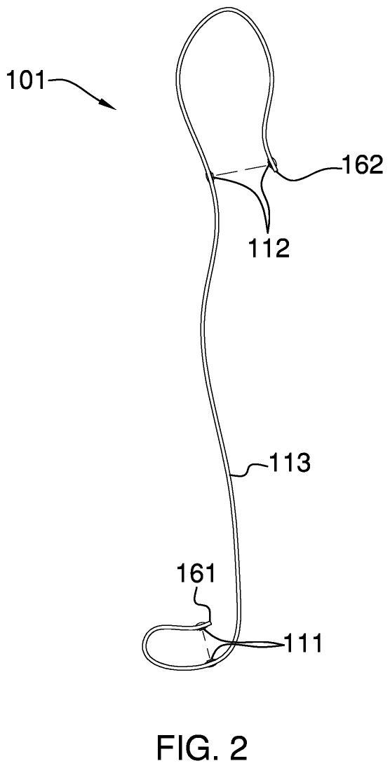

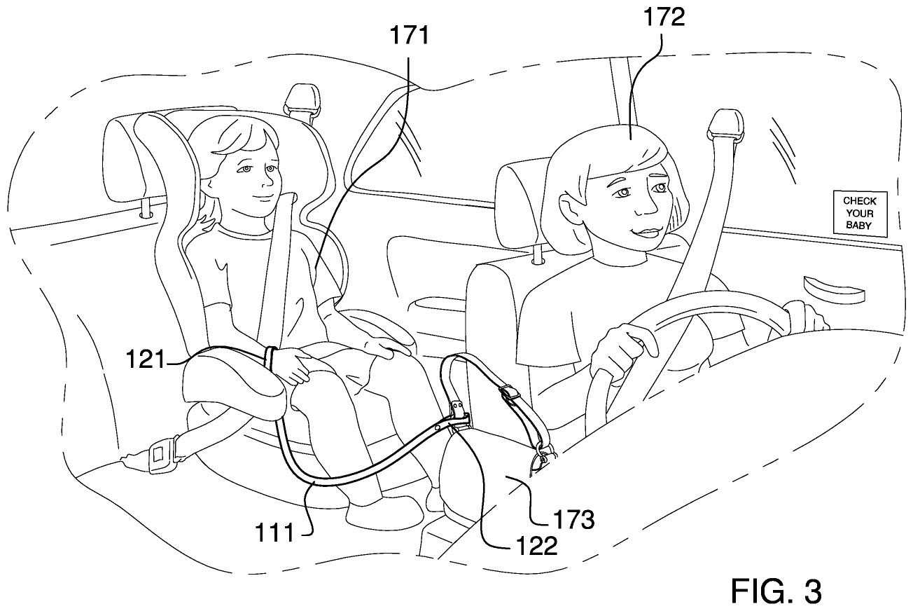

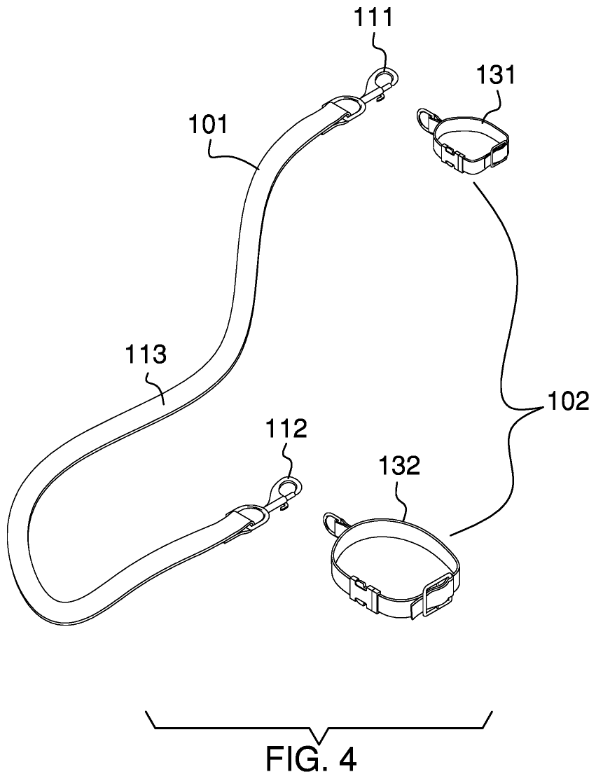

Detailed reference will now be made to one or more potential embodiments of the disclosure, which are illustrated in FIGS. 1 through 4.

The vehicular baby reminder system 100 (hereinafter invention) is a kit. The invention 100 is a safety device. The invention 100 is configured for use with an infant 171. The invention 100 is configured for use with a custodian 172 of the infant 171. The invention 100 is configured for use with a domestic article 173 in the custody of the custodian 172. The invention 100 simultaneously attaches to the infant 171 and the domestic article 173 such that the when the custodian 172 moves with the domestic article 173, the custodian 172 is reminded of their custodial responsibility regarding the infant 171. The infant 171 is defined in greater detail elsewhere in this disclosure. The custodian 172 is defined in greater detail elsewhere in this disclosure. The domestic article 173 is defined in greater detail elsewhere in this disclosure.

The invention 100 comprises a tether 101, a plurality of loops 102, one or more signs 103 and a carton 104. The plurality of loops 102 attach to the tether 101. A first looping structure selected from plurality of loops 102 further attaches to the infant 171. A second looping structure selected from plurality of loops 102 further attaches to the domestic article 173 such that the custodian 172 travels carrying both the domestic article 173 and the infant 171. Each of the one or more signs 103 is a placard that displays a sentiment reminding the custodian 172 of their custodial responsibility regarding the infant 171. The carton 104 is a container used to store the tether 101, the plurality of loops 102, and the one or more signs 103.

The tether 101 is a textile structure. The tether 101 forms a physical attachment between the infant 171 and the domestic article 173 of the custodian 172. The physical attachment formed by the tether 101 prevents the custodian 172 from leaving the vicinity of the infant 171 with the domestic article 173 without being reminded of their custodial responsibility regarding the infant 171. The tether 101 comprises a first fastener 111, a second fastener 112, and a webbing 113. The webbing 113 is further defined with a first end 161 and a second end 162. The use of a webbing 113 as a tether 101 is well-known and documented in the textile arts.

The first fastener 111 is a fastening device. The function of the first fastener 111 is selected from the group consisting of: a) forming a loop in the first end 161 of the tether 101; and, b) attaching a bracelet to the first end 161 of the tether 101. The first fastener 111 is selected from the group consisting of a: a) snap; b) a hook and loop fastener; and, c) a clip.

The second fastener 112 is a fastening device. The function of the second fastener 112 is selected from the group consisting of: a) forming a loop in the second end 162 of the tether 101; and, b) attaching a bracelet to the second end 162 of the tether 101. The second fastener 112 is selected from the group consisting of a: a) snap; b) a hook and loop fastener; and, c) a clip.

The webbing 113 is a textile based webbing structure used to secure the domestic article 173 of the custodian 172 to the infant 171. The use of a webbing 113 for this purpose is well-known and documented in the textile arts.

Each of the plurality of loops 102 is a ring structure. Each of the plurality of loops 102 attaches to an end of the tether 101 selected from the group consisting of the first end 161 and the second end 162. Each loop selected from the plurality of loops 102 attaches to a structure selected from the group consisting of the domestic article 173 of the custodian 172 and the infant 171. Each of the plurality of loops 102 forms a looping structure selected from the group consisting of: a) a textile loop formed in the tether 101; and, b) a bracelet.

In the first potential embodiment of the disclosure, the plurality of loops 102 comprises a first textile loop 121 and a second textile loop 122.

The first textile loop 121 is a looped structure that is formed in the first end 161 of the tether 101. The first textile loop 121 is held in position using the first fastener 111. The first fastener 111 used to form the first textile loop 121 is selected from the group consisting of a snap and a hook and loop fastener. The first textile loop 121 attaches the tether 101 to the infant 171.

The second textile loop 122 is a looped structure that is formed in the second end 162 of the tether 101. The second textile loop 122 is held in position using the second fastener 112. The second fastener 112 used to form the second textile loop 122 is selected from the group consisting of a snap and a hook and loop fastener. The second textile loop 122 attaches the tether 101 to the domestic article 173 of the custodian 172.

In a second potential embodiment of the disclosure, the plurality of loops 102 comprises a first bracelet 131 and a second bracelet 132.

The first bracelet 131 is a bracelet that is worn by the infant 171. The first bracelet 131 is a ring-shaped structure. The first fastener 111 is a clip that is permanently attached to the first end 161 of the tether 101. The first fastener 111 attaches the first end 161 of the tether 101 to the first bracelet 131.

The second bracelet 132 is a bracelet that is attached to the domestic article 173 of the custodian 172. The second bracelet 132 is a ring-shaped structure. The second fastener 112 is a clip that is permanently attached to the second end 162 of the tether 101. The second fastener 112 attaches the second end 162 of the tether 101 to the second bracelet 132.

Each of the one or more signs 103 displays an image 143. The image 143 is formed from indicia that present a sentiment. The sentiment presented by each of the one or more signs 103 is unique but is generally geared towards reminding the custodian 172 of their custodial responsibility regarding the infant 171. The one or more signs 103 are placed in the vicinities of the infant 171 and the domestic article 173 of the custodian 172.

Each of the one or more signs 103 is an individual sign 141 that displays a unique sentiment. The individual sign 141 is a mechanical structure that displays an image 143 intended to remind the custodian 172 of their custodial responsibility regarding the infant 171. Each individual sign 141 is visibly displayed in a location that is proximal to the vicinity of the infant 171. The individual sign 141 comprises a display structure 142 and an image 143.

The display structure 142 is a disk-shaped structure. The display structure 142 presents a planar surface on which an image 143 is displayed. The image 143 is formed from indicia that present a sentiment. The use of an image 143 to remind individuals of their responsibility is well-known and documented in the commercial arts.

The carton 104 is a container. The carton 104 has a composite prism structure. The carton 104 stores the tether 101, the plurality of loops 102, and the one or more signs 103 when the invention 100 is not in use. The carton 104 comprises a containment pan 151 and a covering pan 152. The covering pan 152 encloses the containment pan 151 to form the composite prism structure.

The containment pan 151 is a hollow disk-shaped structure. The containment pan 151 has a pan shape. The containment pan 151 forms the primary containment space of the carton 104. The containment pan 151 is further defined with a first closed face 181 and a first open face 182. The first closed face 181 is a solid surface formed in a face of the disk structure of the containment pan 151. The first open face 182 is an opening formed in the face of the disk structure of the containment pan 151 that is distal from the first closed face 181. The tether 101, the plurality of loops 102, and the one or more signs 103 are placed into the containment pan 151 through the first open face 182.

The covering pan 152 is a hollow disk-shaped structure. The covering pan 152 has a pan shape. The covering pan 152 encloses the containment pan 151. The covering pan 152 is further defined with a second closed face 191 and a second open face 192. The second closed face 191 is a solid surface formed in a face of the disk structure of the covering pan 152. The second open face 192 is an opening formed in the face of the disk structure of the covering pan 152 that is distal from the second closed face 191. The second open face 192 fits over the first open face 182 of the containment pan 151 such that the containment pan 151 inserts into the covering pan 152 thereby enclosing the carton 104.

The perimeter of the second open face 192 of the covering pan 152 is geometrically similar to the perimeter of the first open face 182 of the containment pan 151. The span of the length of the perimeter of the second open face 192 of the covering pan 152 is greater than the span of the length of the perimeter of the first open face 182 of the containment pan 151 such that the first open face 182 will fit within the second open face 192.

The following definitions were used in this disclosure:

Align: As used in this disclosure, align refers to an arrangement of objects that are: 1) arranged in a straight plane or line; 2) arranged to give a directional sense of a plurality of parallel planes or lines; or, 3) a first line or curve is congruent to and overlaid on a second line or curve.

Anchor: As used in this disclosure, anchor means to hold an object firmly or securely.

Anchor Point: As used in this disclosure, an anchor point is a location to which a first object can be securely attached to a second object.

Bracelet: As used in this disclosure, a bracelet is a ring structure that is worn around the wrist.

Buckle: As used in this disclosure, a buckle is a fastening device that is used for joining a first loose end of a strap to a second loose end of the same strap or a different strap. A buckle further comprises a male connector that is attached to a first loose end and a female connector that is attached to a second loose end. The male connector has a pin or other structure that is generally caught by a structure formed in the female connector.

Carton: In this disclosure, the term carton means a prism-shaped box or container that is used to contain a volume of no more than 4 liters. A carton often has a rectangular shape. As a practical example of this definition, a carton is usually made of a waxed cardboard or plastic and often contains beverages or foodstuffs.

Center: As used in this disclosure, a center is a point that is: 1) the point within a circle that is equidistant from all the points of the circumference; 2) the point within a regular polygon that is equidistant from all the vertices of the regular polygon; 3) the point on a line that is equidistant from the ends of the line; 4) the point, pivot, or axis around which something revolves; or, 5) the centroid or first moment of an area or structure. In cases where the appropriate definition or definitions are not obvious, the fifth option should be used in interpreting the specification.

Center Axis: As used in this disclosure, the center axis is the axis of a cylinder or a prism. The center axis of a prism is the line that joins the center point of the first congruent face of the prism to the center point of the second corresponding congruent face of the prism. The center axis of a pyramid refers to a line formed through the apex of the pyramid that is perpendicular to the base of the pyramid. When the center axes of two cylinder, prism or pyramidal structures share the same line they are said to be aligned. When the center axes of two cylinder, prism or pyramidal structures do not share the same line they are said to be offset.

Clip: As used in this disclosure, a clip is a fastener that attaches to an object by gripping or clasping the object. A clip is typically spring loaded.

Composite Prism: As used in this disclosure, a composite prism refers to a structure that is formed from a plurality of structures selected from the group consisting of a prism structure and a pyramid structure. The plurality of selected structures may or may not be truncated. The plurality of prism structures are joined together such that the center axes of each of the plurality of structures are aligned. The congruent ends of any two structures selected from the group consisting of a prism structure and a pyramid structure need not be geometrically similar.

Congruent: As used in this disclosure, congruent is a term that compares a first object to a second object. Specifically, two objects are said to be congruent when: 1) they are geometrically similar; and, 2) the first object can superimpose over the second object such that the first object aligns, within manufacturing tolerances, with the second object.

Correspond: As used in this disclosure, the term correspond is used as a comparison between two or more objects wherein one or more properties shared by the two or more objects match, agree, or align within acceptable manufacturing tolerances.

Custody: As used in this disclosure, custody refers to an object or person that is under the physical control or care of a custodian. The custodian is an appropriate authority responsible for the proper operation, appropriate use, or well-being of the object or person that is in custody.

Disk: As used in this disclosure, a disk is a prism-shaped object that is flat in appearance. The disk is formed from two congruent ends that are attached by a lateral face. The sum of the surface areas of two congruent ends of the prism-shaped object that forms the disk is greater than the surface area of the lateral face of the prism-shaped object that forms the disk. In this disclosure, the congruent ends of the prism-shaped structure that forms the disk are referred to as the faces of the disk.

Domestic Article: As used in this disclosure, a domestic article is an item or object: 1) that is commonly found within a household; or, 2) that is commonly carried or worn by a person. Examples of domestic articles include, but are not limited to, clothing, keys and key fobs, personal data devices, glasses, remote controls, or personal storage items such as purses, briefcases, wallets, or cases.

Fastener: As used in this disclosure, a fastener is a device that is used to join or affix two objects. Fasteners generally comprise a first element which is attached to the first object and a second element which is attached to the second object such that the first element and the second element join to removably attach the first object and the second object. Common fasteners include, but are not limited to, hooks, zippers, magnets, snaps, buttons, buckles, quick release buckles, or hook and loop fasteners.

Form Factor: As used in this disclosure, the term form factor refers to the size and shape of an object.

Geometrically Similar: As used in this disclosure, geometrically similar is a term that compares a first object to a second object wherein: 1) the sides of the first object have a one to one correspondence to the sides of the second object; 2) wherein the ratio of the length of each pair of corresponding sides are equal; 3) the angles formed by the first object have a one to one correspondence to the angles of the second object; and, 4) wherein the corresponding angles are equal. The term geometrically identical refers to a situation where the ratio of the length of each pair of corresponding sides equals 1. Always use Correspond and One to One

Hook and Loop Fastener: As used in this disclosure, a hook and loop fastener is a fastener that comprises a hook surface and a loop surface. The hook surface comprises a plurality of minute hooks. The loop surface comprises a surface of uncut pile that acts like a plurality of loops. When the hook surface is applied to the loop surface, the plurality of minute hooks fastens to the plurality of loops securely fastening the hook surface to the loop surface. A note on usage: when fastening two objects the hook surface of a hook and loop fastener will be placed on the first object and the matching loop surface of a hook and loop fastener will be placed on the second object without significant regard to which object of the two objects is the first object and which of the two objects is the second object. When the hook surface of a hook and loop fastener or the loop surface of a hook and loop fastener is attached to an object this will simply be referred to as the “hook/loop surface” with the understanding that when the two objects are fastened together one of the two objects will have a hook surface and the remaining object will have the loop surface.

Image: As used in this disclosure, an image is an optical representation or reproduction of an indicia or of the appearance of something or someone.

Indicia: As used in this disclosure, the term indicia refers to a set of markings that identify a sentiment.

Infant: As used in this disclosure, an infant refers to a human child who: 1) is under 18 months old; and, 2) has not yet learned to walk.

Loop: As used in this disclosure, a loop is the length of a first linear structure including, but not limited to, shafts, lines, cords, or ribbons, that is: 1) folded over and joined at the ends forming an enclosed space; or, 2) curved to form a closed or nearly closed space within the first linear structure. In both cases, the space formed within the first linear structure is such that a second linear structure such as a line, cord or a hook can be inserted through the space formed within the first linear structure. Within this disclosure, the first linear structure is said to be looped around the second linear structure.

One to One: When used in this disclosure, a one to one relationship means that a first element selected from a first set is in some manner connected to only one element of a second set. A one to one correspondence means that the one to one relationship exists both from the first set to the second set and from the second set to the first set. A one to one fashion means that the one to one relationship exists in only one direction.

Pan: As used in this disclosure, a pan is a hollow and prism-shaped containment structure. The pan has a single open face. The open face of the pan is often, but not always, the superior face of the pan. The open face is a surface selected from the group consisting of: a) an end of the prism structure that forms the pan; and, b) a lateral face of the prism structure that forms the pan.

Perimeter: As used in this disclosure, a perimeter is one or more curved or straight lines that bound an enclosed area on a plane or surface. The perimeter of a circle is commonly referred to as a circumference.

Prism: As used in this disclosure, a prism is a three-dimensional geometric structure wherein: 1) the form factor of two faces of the prism are congruent; and, 2) the two congruent faces are parallel to each other. The two congruent faces are also commonly referred to as the ends of the prism. The surfaces that connect the two congruent faces are called the lateral faces. In this disclosure, when further description is required a prism will be named for the geometric or descriptive name of the form factor of the two congruent faces. If the form factor of the two corresponding faces has no clearly established or well-known geometric or descriptive name, the term irregular prism will be used. The center axis of a prism is defined as a line that joins the center point of the first congruent face of the prism to the center point of the second corresponding congruent face of the prism. The center axis of a prism is otherwise analogous to the center axis of a cylinder. A prism wherein the ends are circles is commonly referred to as a cylinder.

Quick Release Buckle: As used in this disclosure, a quick release buckle is a specific type of buckle wherein the buckle can be readily and easily disconnected by pressing a button or pinching one of the ends of the quick release buckle. Quick release buckles are readily and commercially available.

Ring: As used in this disclosure, a ring is a term that is used to describe a disk-like structure through which an aperture is formed. Rings are often considered loops.

Sentiment: As used in this disclosure, a sentiment refers to a symbolic meaning or message that is communicated through the use of an image, potentially including a text-based image.

Sign: As used in this disclosure, a sign is a placard that displays an image, potentially including a text-based image, which contains some form of a sentiment.

Snap: As used in this disclosure, a snap is a fastener that comprises a male component and a female component. The snap is engaged by pressing the male component into the female component.

Tether: As used in this disclosure, a tether is a cord, line, webbing, or strap that is attached to an object to restrict its movement.

Textile: As used in this disclosure, a textile is a material that is woven, knitted, braided or felted. Synonyms in common usage for this definition include fabric and cloth.

Webbing: As used in this disclosure, a webbing is strong, close woven or knitted fabric that is used for straps or belting. As used in this disclosure, webbing is a fully formed material that is only cut to length for use. Webbing is not formed by cutting broader materials into strips. Webbings have tensile strength but are too flexible to provide compressive strength and are not suitable for use in pushing objects. The two surfaces of a webbing with the greatest surface area are called the faces of the webbing.

With respect to the above description, it is to be realized that the optimum dimensional relationship for the various components of the invention described above and in FIGS. 1 through 4 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A safety kit comprising:
a tether, a plurality of loops, one or more signs and a carton;
wherein the plurality of loops attach to the tether;
wherein the safety kit is configured for use with an infant or a pet;
wherein the safety kit is configured for use with a custodian of the infant or pet;
wherein the safety kit is configured for use with a domestic article in the custody of the custodian;
wherein each of the one or more signs is a placard;
wherein each of the one or more signs is displays a sentiment;
wherein the carton stores the tether, the plurality of loops, and the one or more signs.

2. The safety kit according to claim 1 wherein the tether is adapted to simultaneously attaches to the infant or pet and the domestic article.

3. The safety kit according to claim 2
wherein the tether is a textile structure;
wherein the tether is adapted to form a physical attachment between the infant or pet and the domestic article of the custodian.

4. The safety kit according to claim 3
wherein the tether comprises a first fastener, a second fastener, and a webbing;
wherein the first fastener and the second fastener attach to the webbing;
wherein the webbing is further defined with a first end and a second end.

5. The safety kit according to claim 4
wherein the first fastener is a fastening device;
wherein the second fastener is a fastening device;
wherein the function of the first fastener is selected from the group consisting of: a) forming a loop in the first end of the tether; and, b) attaching a bracelet to the first end of the tether;
wherein the function of the second fastener is selected from the group consisting of: a) forming a loop in the second end of the tether; and, b) attaching a bracelet to the second end of the tether.

6. The safety kit according to claim 5
wherein the first fastener is selected from the group consisting of a: a) snap; b) a hook and loop fastener; and, c) a clip;
wherein the second fastener is selected from the group consisting of a: a) snap; b) a hook and loop fastener; and, c) a clip.

7. The safety kit according to claim 6
wherein each of the plurality of loops is a ring structure;
wherein each of the plurality of loops attaches to an end of the tether selected from the group consisting of the first end and the second end.

8. The safety kit according to claim 7 wherein each loop selected from the plurality of loops attaches to a structure selected from the group consisting of the domestic article of the custodian and the infant.

9. The safety kit according to claim 8 wherein each of the plurality of loops forms a looping structure selected from the group consisting of: a) a textile loop formed in the tether; and, b) a bracelet.

10. The safety kit according to claim 9
wherein the plurality of loops comprises a first textile loop and a second textile loop;
wherein the first textile loop is a looped structure that is formed in the first end of the tether;
wherein the second textile loop is a looped structure that is formed in the second end of the tether.

11. The safety kit according to claim 10
wherein the first textile loop is held in position using the first fastener;
wherein the second textile loop is held in position using the second fastener;
wherein the first fastener used to form the first textile loop is selected from the group consisting of a snap and a hook and loop fastener;
wherein the second fastener used to form the second textile loop is selected from the group consisting of a snap and a hook and loop fastener.

12. The safety kit according to claim 11
wherein the first textile loop is adapted to attach the tether to the infant or pet;
wherein the second textile loop attaches the tether to the domestic article of the custodian.

13. The safety kit according to claim 12
wherein each of the one or more signs displays a unique sentiment;
wherein the one or more signs are placed in the vicinities of the infant or pet and the domestic article of the custodian;
wherein each of the one or more signs is an individual sign;
wherein the individual sign is a mechanical structure;
wherein each individual sign is visibly displayed;
wherein the individual sign comprises a display structure and the image;
wherein the display structure is a disk-shaped structure;
wherein the display structure presents a planar surface on which an image is displayed;
wherein the image is formed from indicia that present a sentiment.

14. The safety kit according to claim 13
wherein the carton is a container;
wherein the carton has a composite prism structure;
wherein the carton comprises a containment pan and a covering pan;
wherein the covering pan encloses the containment pan to form the composite prism structure;
wherein the containment pan is a hollow disk-shaped structure;
wherein the containment pan has a pan shape;
wherein the containment pan is further defined with a first closed face and a first open face;
wherein the covering pan is a hollow disk-shaped structure;
wherein the covering pan has a pan shape;
wherein the covering pan encloses the containment pan;
wherein the covering pan is further defined with a second closed face and a second open face;
wherein the perimeter of the second open face of the covering pan is geometrically similar to the perimeter of the first open face of the containment pan;
wherein the span of the length of the perimeter of the second open face of the covering pan is greater than the span of the length of the perimeter of the first open face of the containment pan such that the first open face will fit within the second open face.

15. The safety kit according to claim 9
wherein the plurality of loops comprises a first bracelet and a second bracelet;
wherein the first bracelet is a ring-shaped structure;
wherein the second bracelet is a ring-shaped structure;
wherein the first bracelet is adapted to be worn by the infant or pet;
wherein the second bracelet is attached to the domestic article of the custodian.

16. The safety kit according to claim 15
wherein the first fastener is a clip that is permanently attached to the first end of the tether;
wherein the second fastener is a clip that is permanently attached to the second end of the tether.

17. The safety kit according to claim 16
wherein the first fastener attaches the first end of the tether to the first bracelet;
wherein the second fastener attaches the second end of the tether to the second bracelet.

18. The safety kit according to claim 17
wherein each of the one or more signs displays a unique sentiment;
wherein the one or more signs are placed in the vicinities of the infant and the domestic article of the custodian;
wherein each of the one or more signs is an individual sign;
wherein the individual sign is a mechanical structure;
wherein each individual sign is visibly displayed.

19. The safety kit according to claim 18
wherein the individual sign comprises a display structure and the image;
wherein the display structure is a disk-shaped structure;
wherein the display structure presents a planar surface on which an image is displayed;
wherein the image is formed from indicia that present a sentiment.

20. The safety kit according to claim 19
wherein the carton is a container;
wherein the carton has a composite prism structure;
wherein the carton comprises a containment pan and a covering pan;
wherein the covering pan encloses the containment pan to form the composite prism structure;
wherein the containment pan is a hollow disk-shaped structure;
wherein the containment pan has a pan shape;
wherein the containment pan is further defined with a first closed face and a first open face;
wherein the covering pan is a hollow disk-shaped structure;
wherein the covering pan has a pan shape;
wherein the covering pan encloses the containment pan;
wherein the covering pan is further defined with a second closed face and a second open face;
wherein the perimeter of the second open face of the covering pan is geometrically similar to the perimeter of the first open face of the containment pan;
wherein the span of the length of the perimeter of the second open face of the covering pan is greater than the span of the length of the perimeter of the first open face of the containment pan such that the first open face will fit within the second open face.
